(19) United States
(12) Patent Application Publication
(10) Pub. No.: US 2026/0079448 A1
(43) Pub. Date: Mar. 19, 2026

(54) WATCH WITH A MECHANO-ELECTRIC GENERATOR

(71) Applicant: The Swatch Group Research and Development Ltd, Marin (CH)

(72) Inventors: Pierpasquale TORTORA, Neuchatel (CH); Cedric Nicolas, Neuchatel (CH); Baptiste Hinaux, Lausanne (CH); Jean-Jacques Born, Morges (CH)

(73) Assignee: The Swatch Group Research and Development Ltd, Marin (CH)

(21) Appl. No.: 19/291,881

(22) Filed: Aug. 6, 2025

(30) Foreign Application Priority Data
Sep. 19, 2024 (EP) 24201470.2

(51) Int. Cl. G04C 10/00; G04B 19/30; H02K 21/24

(52) U.S. Cl. CPC G04C 10/00; G04B 19/30; H02K 21/24

(57) ABSTRACT

A watch including, in a case (6b), a movement (44a) and a mechano-electric generator (88) including a stator (106a, 106b, 18a, 18b) and a rotor (92), one carrying permanent magnets (18a, 18b) and the other carrying coils (14). The rotor has an annular structure and is rotationally guided by at least one ball bearing (100a), the rotor having over its entire height a free internal space (130) through which the geometric axis of rotation of the rotor moves and in which the movement is at least partially located. The watch has a barrel forming a rotor drive device that can be activated on command. The watch may also have a lighting device (64) powered by the coils. The rotor (92) may carry the coils, which are connected, via an electrical circuit with no accumulators, to the lighting device which is securely arranged on the rotor.

### CROSS-REFERENCE TO RELATED APPLICATIONS

This application claims priority to European Patent Application No. 24201470.2, filed on Sep. 19, 2024, the entire contents of which are incorporated herein by reference.

### TECHNICAL FIELD OF THE INVENTION

The present invention relates to a watch incorporating a mechano-electric generator. In particular, the invention relates to a watch fitted with a mechanical movement, meaning one in which the drive on an analogue time display is entirely mechanical, with a barrel as the source of energy.

In particular, the invention relates to such a watch fitted with a lighting device for a display space, in which there is an analogue display device, this lighting device being powered by the mechano-electric generator.

### TECHNOLOGICAL BACKGROUND

There have already been mechanical watches on the market with various additional lighting systems. In a particular embodiment, disclosed in document EP 3838424, a lighting device is powered by a micro-generator, also referred to as a “generator”, which is rotated by a barrel spring and acts as a speed regulator for a striking work. The coils on the micro-generator are carried by its stator, whereas the rotor conventionally carries permanent magnets.

With regard to the micro-generator, it should be noted that this generator and the corresponding electrical and electronic circuits are located entirely within the horology movement and take up a relatively large space within the movement. If the horology movement is to be displayed through a glass in the back of the watchcase, at least the generator is clearly visible. This gives the horology movement a hybrid mechanical and electrical appearance, which is particularly unsuitable in top-of-the range watches where the value of the watch lies largely in the mechanical horology movement. Moreover, the significant amount of space occupied by the generator in the movement increases its volume. In addition, the height of the generator is significant because on at least one disc the rotor comprises a plurality of magnets, which are axially superimposed on coils in the stator, and a central arbor carrying said at least one disc, this central arbor being pivoted at both ends in supports for the movement, for example in a generator plate and bar.

It should also be noted that the lighting system provided has drawbacks for a watch fitted with a mechanical movement, more specifically for a top-of-the-range watch for which it is important to conserve, insofar as possible, the exclusively mechanical nature of the movement. The lighting system in fact comprises at least one electroluminescent element, for example at least one LED, an electrical circuit, an electronic circuit and at least one electrical energy accumulator which are arranged on a support in the horology movement, at the periphery of the rotor in the microgenerator, thereby introducing an electronic-type device and electrical energy storage means into the horology movement.

### SUMMARY OF THE INVENTION

The invention first aims to provide a watch equipped with a mechano-electric generator that provides a solution to the various aforementioned problems that arise when a micro-generator (hereinafter referred to as a “mechano-electric generator” or simply a “generator”) is incorporated into a watch movement.

The invention then aims to provide a watch equipped with a mechano-electric generator and a lighting device and that provides a solution to the various aforementioned drawbacks in connection with the lighting system.

The invention further aims to provide a lighting device for an analogue watch display, in particular the hands and the dial, which is aesthetic, discreet and suitable for a top-of-the-range watch and which also does not require the installation of specific optical means in the elements of the analogue display itself, in particular in the dial.

To this end, the present invention first relates to a watch comprising a movement, a mechano-electric generator and a case incorporating the movement and the mechano-electric generator, this generator comprising a stator and a rotor, one carrying permanent magnets and the other coils, the permanent magnets and the coils being arranged such that, when the rotor is rotated, the permanent magnets move in a reference frame connected to the coils, successively opposite each coil with their respective magnetic axes running through the coil. The rotor has an annular structure and is rotationally guided by at least one ball bearing, the rotor having over its entire height a free internal space through which the geometric axis of rotation of this rotor moves and in which the movement is at least partially located.

According to one advantageous variant, the rotor on the mechano-electric generator is located substantially entirely, preferably entirely, in a space peripheral to the movement. “Entirely within a peripheral space” is taken to mean that the movement is comprised within a geometric volume that internally follows its external lateral surfaces and that the rotor does not penetrate this volume, with the possible exception of an internal toothing on the rotor that meshes with a wheel of a mechanical drive device on the generator if this mechanical drive device is comprised in the movement. It should be noted that, in a particular embodiment which will not be described, the mechanical rotor drive device can be separate from the movement and located in the watchcase outside the volume of the movement. According to a preferred variant, the stator on the mechano-electric generator is located substantially entirely, preferably entirely, in a space peripheral to the movement. With regard to the stator, “substantially entirely in a peripheral space” is taken in this case to mean that the coils are substantially outside the volume of the movement, but part of the coil support can optionally penetrate into this volume, in particular to secure it to the movement.

In one advantageous variant, the axial dimension of the mechano-electric generator is smaller than the axial dimension of the movement.

In one advantageous embodiment, the watch comprises a plurality of ball bearings with a diameter smaller than the inner radius of the rotor, preferably half this radius. Each ball bearing in said plurality comprises a fixed part and a mobile part moving between the fixed part and the rotor, each mobile part and the rotor being configured so that the rotor is supported only by the plurality of mobile parts in the plurality of ball bearings and is capable of rotating around the rotor's geometric axis of rotation.

In a first main embodiment, the rotor comprises an unbalance enabling it to be actuated in free rotation by movements performed by a user of the watch; and in that the coils are connected to an electrical accumulator via a rectifier.

In a second main embodiment, the watch comprises a mechanical rotor drive device, this mechanical drive device comprising a barrel and being arranged so that it can be activated on command by a user of the watch.

In one advantageous embodiment, the watch comprises a lighting device powered by the coils. In a preferred variant of this embodiment, the rotor carries the coils, which are connected, directly or via an electrical circuit with no accumulator and where appropriate an electronic circuit, to said lighting device which is securely arranged on the rotor.

### BRIEF DESCRIPTION OF THE FIGURES

The invention will be described in greater detail below with reference to the appended drawings, which are given by way of non-limiting examples, in which:

FIG. 1 is a partial cross-section of a watch according to a first main embodiment of the invention;

FIG. 2 is a partial cross-section of a watch according to a second main embodiment of the invention;

FIG. 3 is a horizontal cross-section along line III-III in FIGS. 4 and 5 of a watch according to one advantageous embodiment for using the mechano-electric generator as a source of energy for a lighting device in a display space on the watch;

FIG. 4 is a partial cross-section along section line IV-IV of the watch in FIG. 3; and

FIG. 5 is a partial cross-section along section line V-V of the watch in FIG. 3.

### DETAILED DESCRIPTION OF THE INVENTION

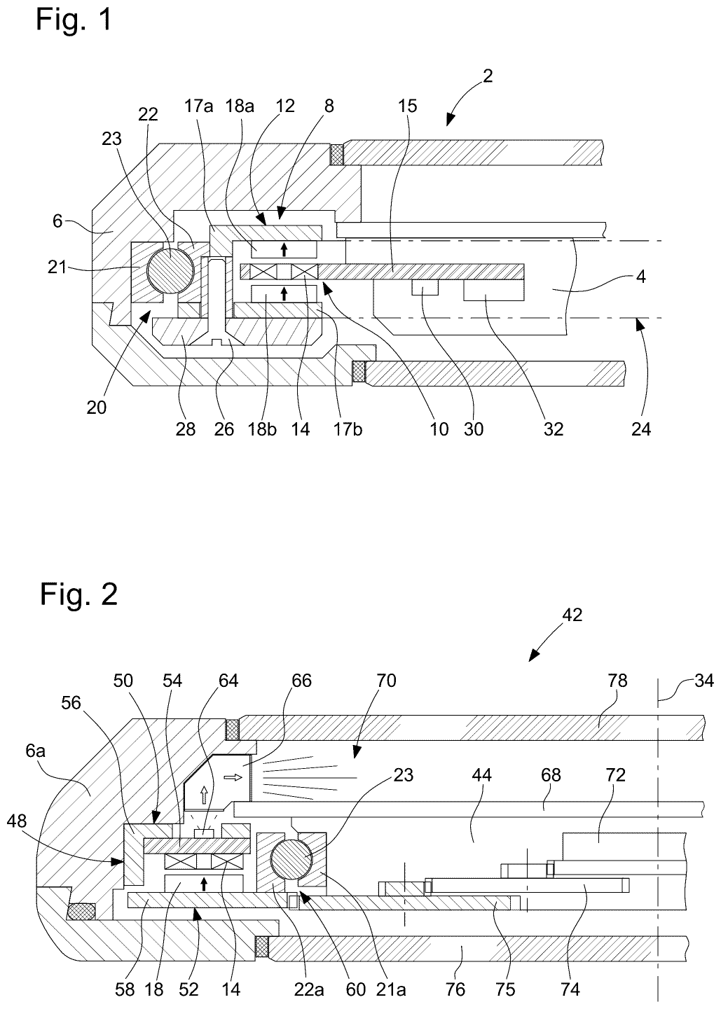

With reference to FIG. 1, a first main embodiment of a watch according to the invention will be described below.

The watch 2 comprises a movement 4, a mechano-electric generator 8 and a case 6 incorporating the movement and the mechano-electric generator. The generator 8 comprises a stator 10 and a rotor 12, the rotor carrying permanent magnets 18a, 18b and the stator carrying coils 14. Generally speaking, the permanent magnets and coils are arranged so that, when the rotor is rotated, the magnets move successively, in a frame of reference linked to the coils, at least partially opposite each coil with their respective magnetic axes (indicated in the figures by arrows) running through the coil. According to the invention, the rotor 12 has an annular structure and is rotationally guided by at least one ball bearing 20. In addition, over its entire height, the rotor has a free interior space 24 through which this rotor's geometric axis of rotation (similar to the axis 34 as seen in FIG. 2) moves and in which the movement 4 is partially located.

In the advantageous variant of the first main embodiment shown in FIG. 1, the rotor 12 has a ferromagnetic structure, formed in this case into two annular parts 17a and 17b, with its cross-section defining an overall C-shape (or more exactly a U-shape with straight portions). More specifically, part 17a is L-shaped and carries a first row of permanent magnets 18a located above the coils 14, and part 17b is straight and carries a second row of permanent magnets 18b located below the coils 14. The coils 14 are thus advantageously located between pairs of magnets with the same polarity and axially aligned, the magnetic axes of the magnets also being axial. To limit the thickness of the generator and easily allow the magnets of each pair to be equidistant from the coils, the coils are located in openings in a support 15, optionally forming a PCB, to which the coils are secured. The coils 14 and the pairs of magnets 18a, 18b are circularly arranged with the axis of rotation of the rotor as the central axis. In a first variant, the number of magnets in each row of magnets is equal to the number of coils foreseen, the number of magnets being, in a non-limiting manner, advantageously foreseen between twenty-four and forty-eight. In this case, all of the magnets have the same polarity (same direction of polarisation). In a second variant, the generator has twice as many magnets per row of magnets, and therefore pairs of magnets, as it has coils. In the latter case, the magnets in each row of magnets, or pairs of magnets, have alternating polarities.

In the variant shown in FIG. 1, a single ball bearing 20 is provided, consisting of a fixed annular part 21 and a mobile annular part 22, between which the balls 23 are located. In this variant, the mobile annular part 22 forms part of the rotor 12. In a first variant (the one shown in FIG. 1), the fixed part 21 of the ball bearing 20 is located on the outside of the rotor 12 and secured to the case 6. The rotor on the mechano-electric generator 8 is located entirely in a space peripheral to the movement 4, which is advantageous because this rotor does not obstruct the movement and this design makes it possible to have the rotor and the stator coils outside the cylindrical volume which rises axially from the lower glass of the case 6. According to the variant considered, only the support 15 for the coils 14 can partially penetrate this cylindrical volume. Peripheral space” is taken to comprise the space laterally surrounding the geometric volume defined by movement 4, meaning by all of its external surfaces.

To mount the generator 8 in the case 6 of the watch 2, it is provided that the ball bearing 20 with the upper part 17a of the rotor carrying the upper magnets 18a, is first introduced into the case from the back side of this case through the lower opening in its middle (the back being removed for mounting the generator and the movement) and the fixed annular part 21 is assembled to the case 6. It should be noted that the upper part 17a is secured beforehand to the mobile annular part 22 of the ball bearing. The movement 4 and stator 10 are then inserted into the case, also through said lower opening, optionally also with a dial, and the movement is secured in the case. It should be noted that the stator can be secured to the movement beforehand or can be secured to the movement after it has been mounted in the case 6. In a variant not shown, the stator is secured to a fitting circle 4 on the movement. Lastly, the lower part 17b of the rotor is added with magnets 18b and this lower part 17b is secured to the upper part 17a to form the rotor 12 and a magnetic circuit joining magnets 18a to magnets 18b. The two parts are secured with screws 26 that are screwed into threaded tubes attached to the mobile part 22 and to the upper part 17a of the rotor. It should be noted that the lower part 17b extends radially beyond the upper part 17a to ensure that these two parts are rigidly and stably secured.

The first main embodiment relates to a watch in which the mechano-electric generator 8 is a source of electrical energy provided to transform mechanical energy from the movements of a user's arm into electrical energy which is stored in the watch so that it can then power at least one electrical and/or electronic device or system incorporated in the watch. To this end, the rotor 12 carries an unbalance 28. The rotor can also be said to comprise an unbalance 28, since this unbalance is secured to the rotor and rotates with it. This unbalance extends over an angular distance of 180°, for example. In this way, the unbalance enables the rotor 12 to be rotationally actuated by the movements of a user of the watch. To store the electrical energy produced by the generator 8, the coils 14 are connected to an electrical accumulator 32 via a rectifier 30. These electrical elements 30 and 32 are arranged, in the variant shown, on the support 15 of the stator 10, this support forming a PCB through which the coils, advantageously arranged in a row, are connected to the rectifier which rectifies the sinusoidal electric signal provided by the generator to enable electrical energy to be stored in the accumulator 32, in particular a rechargeable battery.

It should be noted that the PCB 15 partially penetrates the movement 4. This means that the mechano-electric generator is located almost entirely in a space peripheral to the movement. In a first variant, the PCB forming the stator 10 and carrying the electrical elements is entirely located at the periphery of the movement, secured to the movement or alternatively to the watchcase or to a fitting circle. In a second variant, two ends of the plurality of coils joined in a row are connected by two wires or by a flexible connector or by another type of electrical connector to two electrical plates on a PCB on which electrical elements 30 and 32 are arranged, this PCB being separate from the support that forms the stator 10 and which is located entirely at the periphery of the movement 4. In the first variant and the second variant, the stator and therefore the generator are located entirely in a space peripheral to the movement, so that the movement is separate from the generator, the latter being peripheral to the movement that is located inside this generator.

With reference to FIG. 2, a second main embodiment of a watch according to the invention will be described below.

The watch 42 according to the second main embodiment of the invention differs from the first main embodiment primarily in that the rotor 52 on the mechano-electric generator 48 is driven, on command, by a gear train (formed by the wheels 74, 75) from a barrel 72 on the movement 44, this barrel storing mechanical energy, through manual or automatic winding via an oscillating mass, and being dedicated to a device for lighting the watch in which the electrical energy source is the generator 48. Generally speaking, the watch comprises a mechanical rotor drive device, this mechanical drive device comprising a barrel and being arranged so that it can be activated on command by a user of the watch to drive the rotor on the generator and thus produce electrical energy.

The generator 48 comprises a stator 50 and a rotor 52, the rotor carrying permanent magnets 18 and the stator carrying coils 14. The permanent magnets and coils are arranged such that, when the rotor is rotated, the permanent magnets move in a reference frame connected to the coils, successively at least partially opposite each coil with their respective magnetic axes running through the coil. According to the invention, the rotor 52 has an annular structure and is rotationally guided by a ball bearing 60. Over its entire height, the rotor 52 has a free interior space through which this rotor's geometric axis of rotation 34 moves and in which the movement 44 is partially located. The rotor 52 on the mechano-electric generator is located entirely in a space peripheral to the movement. In the advantageous variant shown, the stator 50 on the mechano-electric generator 48 is also located entirely in a space peripheral to the movement 44. Moreover, the axial dimension of the mechano-electric generator 48 is smaller than the axial dimension of the movement 44. Incorporating the generator 48 into the watch 42 does not increase its thickness. Furthermore, it can be easily mounted in the case 6a and the space above the movement 44 is not obstructed by the generator. This latter characteristic is particularly useful with regard to the watch 42, which comprises a device for lighting the display space 70, located between the dial 68 and the upper glass 78, from the periphery of this space 70 (this lighting device will be described in more detail later).

The ball bearing 60 is formed by a fixed part 21a and by a mobile part 22a between which the balls 23 are located, the mobile part being annular and forming part of the rotor 52 or, in other words, being attached to the rotor. The variant shown is characterised by the fact that the fixed part 21a of the ball bearing 60 is located on the inside of the rotor 52 and is secured to the movement 44. In particular, the fixed part 21a forms a bow that encloses the movement 44, for example in its median zone as shown in FIG. 2. Only the wheel 75 on the rotor drive device moves beneath the ball bearing 60 and meshes with the internal toothing of the rotor, which is machined on the inside edge of a ferromagnetic bow 58 forming the rotor 52 and carrying the bipolar permanent magnets 18. The bow 58 is attached to the mobile part 22a of the ball bearing 60 and, together with a ferromagnetic annular part 56 of the stator 50, forms a magnetic circuit for closing the magnetic fields generated by the magnets 18, so that they move optimally through the coils 14. The annular part 56 of the stator has an L-shaped cross-section and is secured to the case 6a. The annular part 56 carries an annular PCB 54, arranged under its horizontal part, under which the coils 14 are arranged facing the magnets 18. As a non-limiting example, the PCB 54 carries between twenty and forty coils evenly distributed around the axis of rotation 34. The rotor 52 carries the same number of magnets with the same polarity or double the number of magnets with alternating polarity, these magnets being evenly distributed over the bow 58. The generator 48 differs from the generator 8 in the first embodiment mainly in that the rotor 52 carries a single row of magnets arranged in the same geometric plane perpendicular to the axis of rotation 34, these magnets thus all being on the same side of the coils 14.

Next, the second main embodiment differs from the first main embodiment in that the lighting device on the watch is powered substantially in real time by the generator 48 (more specifically by the coils 14 on the generator 48 when the rotor 52 rotates at a speed above a given minimum value), directly or by means of an electrical and/or electronic circuit with no electrical energy accumulator, such a circuit optionally having at least one smoothing capacitor made of solid material (such a smoothing capacitor is not an electrical energy accumulator because it does not store energy). The electrical and/or electronic circuit can comprise, in particular, a Graetz rectifier bridge.

In the variant viewed, the lighting device is formed of a plurality of electroluminescent diodes 64 (LEDs 64) and of an annular light guide structure 66 forming a flange on the watch. The stator 50 carries the coils, which are connected, either directly or via an electrical circuit with no accumulator and, where appropriate, an electronic circuit, to the plurality of electroluminescent diodes 64 electrically arranged in parallel. The lighting device is preferably arranged on the stator, the annular PCB 54 carrying the coils 14 on one side and the LEDs 64 on the other. The PCB also carries the various electrical connections and any planned electrical and/or electronic circuits. As a non-limiting example, between six and eighteen LEDs are foreseen, these LEDs being angularly and evenly distributed. It should be noted that the LEDs are located in through openings in the ferromagnetic annular part 56 facing the annular light guide structure 66. The annular light guide structure 66 has a surface for injecting the light produced by the LEDs, this injection surface being located above the LEDs, and a cylindrical surface for extracting this light defining the display space 70 and allowing the light to exit the light guide to enter this display space.

In this second embodiment, the movement 44 can advantageously be of the mechanical type (with no electrical or electronic elements). All of the electrical and electronic elements comprised in the watch are arranged at the periphery of the mechanical movement 44, particularly the generator 48 and the lighting device 64 for the display space 70. The lower glass 76 does not reveal any electrical or electronic elements, or even any permanent magnets in the generator (it should be noted that in the field of horology permanent magnets that can be incorporated are recognised as non-electrical/electronic). In a first variant, the ball bearing 60 is secured to a fitting circle on the mechanical movement 44. In a second variant, the ball bearing is arranged, as in the variant in the first embodiment described, on the outside of the rotor and secured to the case 6a.

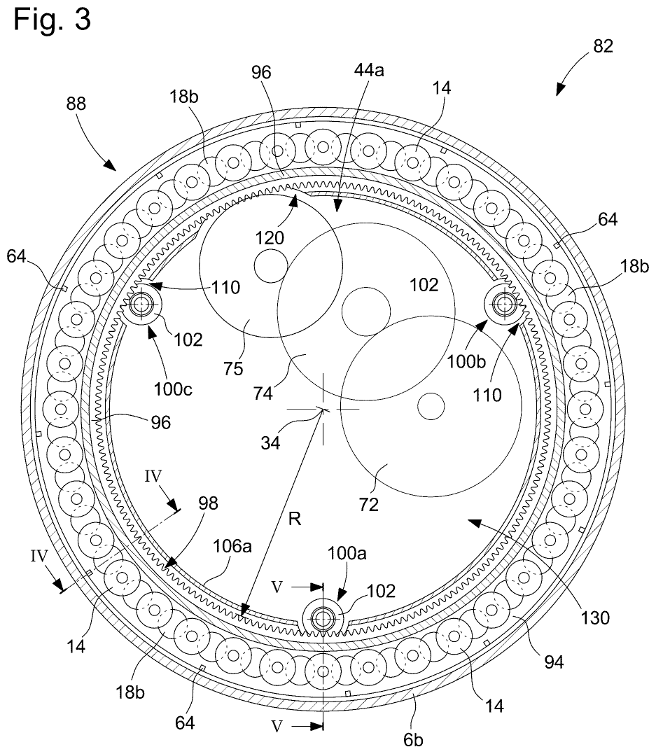

With reference to FIGS. 3 to 5, an advantageous embodiment of the invention will be described hereafter for a watch comprising a lighting device for a display space that is powered by a mechano-electric generator. Various characteristics of the invention already described above will not all be described again, but the distinctive elements of this advantageous embodiment will be presented first.

The watch 82 comprises a case 6b incorporating a movement 44a (partially shown in FIG. 3; it is located between the dial 68 and the back of the case) and a mechano-electric generator 88 located in a region peripheral to the movement. The generator 88 comprises a stator 90 and a rotor 92, which has an annular structure and is rotationally guided, according to a first main characteristic of this advantageous embodiment, by at least two ball bearings, preferably at least three ball bearings 100a, 100b, 100c. Generally speaking, the watch 82 comprises a plurality of ball bearings with a diameter smaller than the inner radius R of the rotor, preferably less than half this inner radius. Each ball bearing in said plurality comprises a fixed part 101 and a mobile part 102 moving between the fixed part and the rotor 92, each mobile part and the rotor being configured so that the rotor is supported only by the plurality of mobile parts in the plurality of ball bearings and is capable of rotating around the central geometrical axis 34 of the rotor, which is its axis of rotation. Each bearing conventionally comprises balls 103 between its fixed part and its mobile part. The particular aspect in this case compared with previous embodiments is that the mobile part of the ball bearings is not attached to the peripheral annular rotor 92 and is therefore not part of this rotor. The mobile parts roll along a track 97 machined laterally in an inner part 96 of the rotor.

The track 97, for example, has a cross-sectional profile defining three straight segments, the dimensions of which are designed so that each mobile part 102 has a small clearance in the groove forming said track and is in contact along said profile, according to the spatial direction of the watch, at one point or two points. Preferably, in this advantageous embodiment, each ball bearing is located on the inner side of the rotor and each fixed part is mounted in the movement 44a. In one variant, the fixed parts 101 are mounted on a fitting circle on the movement. The rotor 92 has internal toothing 98 that meshes with a wheel 75 of a drive train (wheels 74 and 75) arranged between a barrel 72 and the rotor. The drive mechanism on the generator is designed so that it can drive the generator on command in a controlled manner, in particular with an angular rotational speed higher than a minimum velocity required for the lighting device to function correctly, depending on the generator arrangement 88, as long as the barrel is wound above a lower threshold.

As in the other embodiments, over its entire height, the rotor 92 has a free interior space 130, through which the rotor's geometric axis of rotation 34 moves and in which the movement 44a is partially located. Next, the rotor 92 is located substantially entirely in a space peripheral to the movement. In fact, in the variant shown, only the three ball bearings associated with the rotor and supporting the latter, leaving it free to rotate, and the drive wheel 75, which meshes with the internal toothing 98 of the rotor, are in contact with the rotor 92 but located inside the latter. It can therefore be said that, in the variant shown, the rotor is located entirely in a space peripheral to the movement 44a. Moreover, the stator 90 on the generator is also located substantially entirely in a space peripheral to the movement. In fact, while the recesses 110 and 120 in the stator are not considered to be part of the volume of the stator itself, it can be said that the stator 90 is also located entirely in a space peripheral to the movement. Hence, the mechano-electric generator is arranged substantially entirely, preferably entirely, in a space peripheral to the movement of the watch. Thus, in the variant shown, the movement is located substantially entirely within the generator 88, in an internal volume of this generator which is defined by the stator 90, in fact entirely within this internal volume according to the description above and the height of this generator in the variant shown.

According to a second main characteristic of the advantageous embodiment described herein, the rotor 92 advantageously carries the coils 14, which are connected, directly or via an electrical circuit with no accumulator and, where appropriate, an electronic circuit, to a lighting device, formed by a plurality of electroluminescent diodes 64 (LEDs 64) fixedly arranged on the rotor. More specifically, the rotor comprises an annular support 94, forming a rigid PCB (“Printed Circuit Board”), that has circular openings in which the coils 14 are located, which are secured to the annular support 94 which is itself carried by the inner part 96 of the rotor. The LEDs, the various electrical connections forming an electrical circuit and, where appropriate, any electronic circuits other than the LEDs, being arranged on and carried by the PCB. The rotor thus carries all of the electrical and electronic equipment formed by the plurality of electroluminescent diodes, the coils of the generator 88, the electric interconnection circuit and, where appropriate, any other electrical or electronic component relating to the lighting device and to the mechano-electric generator that powers it.

The stator 90 comprises a first row of permanent bipolar magnets 18a, with axial magnetisation, which are carried at the bottom by a first part 106a of an annular ferromagnetic structure forming a magnetic circuit for closing the magnetic fields of the first row of magnets 18a and also of the second row of permanent magnets 18b carried at the top by the second part 106b of the annular structure, which is fixed in the embodiment described in this case, unlike the variant in the first main embodiment described previously where the rotor comprised a similar annular structure that carried both sets of magnets. The annular structure comprises recesses 110, for the ball bearings 100a, 110b and 110c, and a recess 120 for the drive wheel 75. These recesses are machined into the lateral wall (axial/vertical wall) and optionally, as shown, also into the second part 106b (lower part on the back side of the case) to make it easier to fit the ball bearings and the drive wheel 75.

In a first variant shown in FIG. 3, the number of magnets in each row of magnets is equal to the number of coils foreseen, this number being thirty-six in the variant shown. In an advantageous and non-limiting manner, said number is foreseen to be between twenty and forty. In a second variant, the mechano-electric generator comprises twice as many magnets per row as there are coils, the magnets in each row having alternating polarities.

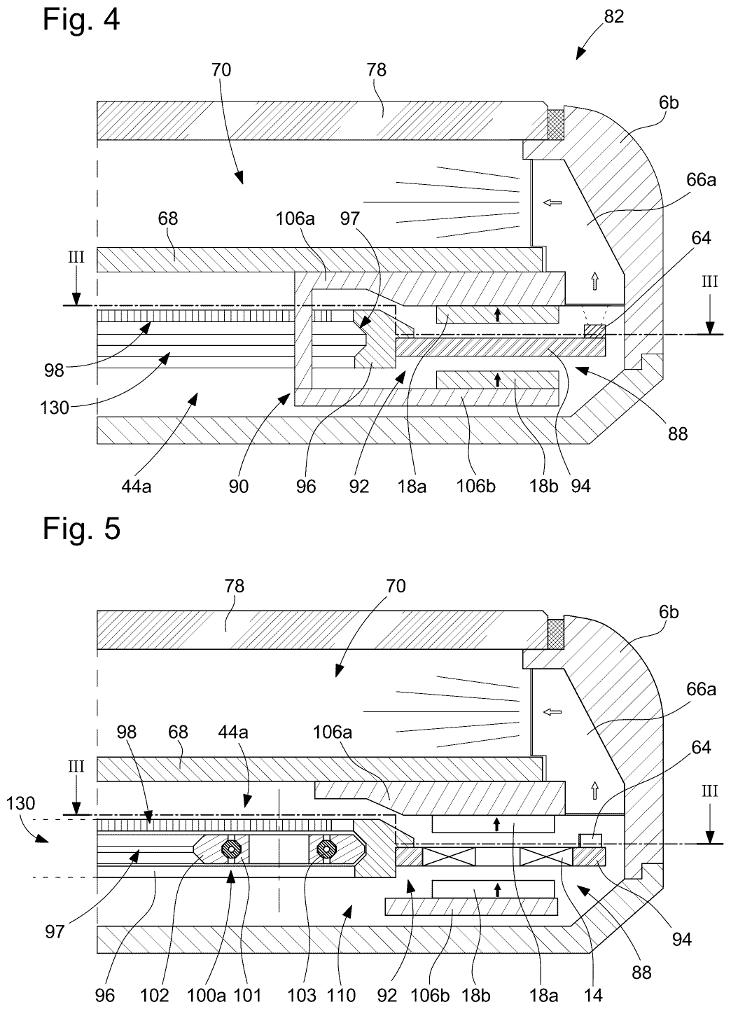

The lighting device is combined with a light guide structure 66a, similar to the one described in the second embodiment. The light guide structure is arranged to conduct the light produced by the lighting device, namely the LEDs 64, towards a display space 70, in which there is an analogue display device (not shown) of the watch, the display space being located between the dial 68 and the upper glass 78. According to a preferred variant shown in FIGS. 4 and 5, the light guide structure forms a flange on the watch surrounding said display space 70. The light guide structure has a lower annular surface that defines an injection surface for the light produced by the LEDs, and a cylindrical surface laterally defining the display space 70 and a light extraction surface. The cross-sectional profile of the light guide structure, in particular the rear portion, can be optimised to effectively guide light to the extraction surface. The surfaces of the light guide structure, in particular the rear surface, can be treated or coated with one or more layers, particularly reflective layers. In the variant embodiment described in this case, it is advantageous for the LEDs 64 to be located on the outer side of the coils 14, given that the light guide structure forms a flange and is therefore a part located at the periphery of the dial 68.

The advantageous embodiment described in this case has a major advantage over the variant in the second main embodiment described above with regard to the lighting of the display space 70. This major advantage arises from the fact that the LEDs are arranged on the rotor and therefore rotate along with it. In this way, the cylindrical surface of the structure 66a defining the flange, is swept by the light produced by each of the LEDs in a tangential direction perpendicular to the rotational axis 34, or in other words in an angular direction. With a sufficient number of LEDs, for example twelve as shown in FIG. 3, and a sufficiently high rotational speed of the rotor, for example two to four rotations/second, the user's eye perceives virtually homogeneous and virtually stationary lighting of the display space because the lighting only occurs when the generator is activated and the rotor is rotated, with the electrical energy generated being provided instantaneously to the LEDs 64. In the second embodiment, the LEDs are arranged on the stator and remain stationary when powered (rotor rotated), so that it is difficult or impossible to produce angularly uniform lighting across the cylindrical surface of the flange. In the latter case, particularly with twelve LEDs, the lighting of the zones on the dial comprising, for example, marks or numerals indicating the hours can be enhanced.

In a first variant, instead of the light guide structure 66a, there can be an empty space above the LEDs which is delimited by a reflective surface that is configured so as to best reflect the light rays towards the display space 70 and in particular the dial 68. The display space is advantageously closed by a cylindrical part which is at least partially transparent to the light produced by the LEDs at least radially towards the display space and therefore towards the central axis of rotation 34, this cylindrical part being traversed by the light which is produced by the LEDs and reflected by said reflective surface. This reflective surface can be defined by an inner surface of the watchcase or by a specific part inserted into the case.

In a second variant, a light-guide structure transparent to the light produced by the LEDs is provided, which has a light extraction surface arranged behind a cylindrical flange forming a cylindrical wall defining the display space, this cylindrical flange being at least partially transparent to the light of the incident LEDs on this cylindrical flange, towards the display space.

Lastly, in another embodiment of a watch with a generator according to the invention and where the rotor is also supported by a plurality of ball bearings of the type described above in the advantageous embodiment, each ball bearing is located on the outside of the rotor and each fixed part is secured to the watchcase.

1. A watch, comprising:
a movement;
a mechano-electric generator; and
a case incorporating the movement and the mechano-electric generator,
the generator comprising a stator and a rotor, one carrying permanent magnets and the other carrying coils, the permanent magnets and the coils being arranged such that, when the rotor is rotated, the permanent magnets move in a reference frame connected to the coils, successively at least partially opposite each coil with their respective magnetic axes running through the coil,
wherein the rotor has an annular structure and is rotationally guided by at least one ball bearing, the rotor having over its entire height a free internal space, through which the geometric axis of rotation of the rotor moves and in which the movement is at least partially located.

2. The watch according to claim 1, wherein the rotor on the mechano-electric generator is located substantially entirely, preferably entirely, in a space peripheral to the movement.

3. The watch according to claim 2, wherein the stator on the mechano-electric generator is located substantially entirely, preferably entirely, in a space peripheral to the movement.

4. The watch according to claim 2, wherein the axial dimension of the mechano-electric generator is smaller than the axial dimension of the movement.

5. The watch according to claim 2, wherein the ball bearing is formed by a fixed part and by a mobile part between which the balls are located, the mobile part being annular and the mobile part forming part of the rotor or being attached to the rotor.

6. The watch according to claim 5, wherein the fixed part of the ball bearing is located on the outside of the rotor and secured to said case.

7. The watch according to claim 5, wherein the fixed part of the ball bearing is located on the inside of the rotor and secured to said movement.

8. The watch according to claim 2, wherein the watch comprises a plurality of ball bearings with a diameter smaller than the inner radius (R) of the rotor, less than half of the inner radius; and wherein each ball bearing in said plurality comprises a fixed part and a mobile part moving between the fixed part and the rotor, each mobile part and the rotor being configured such that the rotor is supported solely by the plurality of mobile parts in the plurality of ball bearings and is capable of rotating around said geometrical axis of rotation.

9. The watch according to claim 8, wherein each ball bearing is located on the inner side of the rotor and each fixed part is secured to said movement.

10. The watch according to claim 8, wherein each ball bearing is located on the outer side of the rotor and each fixed part is secured to said case.

11. The watch according to claim 2, wherein the rotor comprises an unbalance or is attached to an unbalance, which allows the rotor to be actuated in free rotation by movements performed by a user of the watch; and wherein the coils are connected to an electrical accumulator via a rectifier.

12. The watch according to claim 2, further comprising a mechanical rotor drive device, the mechanical drive device comprising a barrel and being arranged so that it can be activated on command by a user of the watch.

13. The watch according to claim 12, further comprising a lighting device that is powered by the coils.

14. The watch according to claim 13, wherein the stator carries the coils, which are connected, directly or via an electrical circuit with no accumulator, to said lighting device.

15. The watch according to claim 14, wherein the lighting device is securely arranged on the stator.

16. The watch according to claim 13, wherein the rotor carries the coils, which are connected, directly or via an electrical circuit with no accumulator, to said lighting device which is securely arranged on the rotor.

17. The watch according to claim 13, wherein the lighting device comprises or is connected to at least one light guide structure arranged to conduct the light produced by the lighting device towards a display space in which an analogue watch display device is located.

18. The watch according to claim 17, wherein the light guide structure forms a flange on the watch surrounding said display space or has a light extraction surface arranged behind a at least partially transparent flange, to said incident light, towards the display space.
